(19) United States
(12) Patent Application Publication
(10) Pub. No.: US 2019/0096208 A1
(43) Pub. Date: Mar. 28, 2019

(54) SUBSTANCE RELEASE BENEFIT DENIAL SECURITY DEVICE

(71) Applicant: Checkpoint Systems, Inc., Thorofare, NJ (US)

(72) Inventor: Benoit Perreau, Weddington, NC (US)

(21) Appl. No.: 15/714,758

(22) Filed: Sep. 25, 2017

(51) Int. Cl. G08B 13/22; G07C 9/00

(52) U.S. Cl. CPC G08B 13/22; G07C 9/00007

(57) ABSTRACT

Apparatuses and methods associated with a substance release benefit denial security device are provided. One example security device includes a container, a locking assembly affixed to the container, and an electronic assembly affixed to the container. The electronic assembly may include a radio frequency receiver and processing circuitry. The security device may also include a benefit denial assembly, which includes a substance disposed in a canister and a release mechanism configured to release the substance into the container. The processing circuitry may be configured to receive a gate detected signal from the radio frequency receiver in response to the radio frequency receiver receiving a wireless signal, and in response to receiving the gate detected signal from the radio frequency receiver, transmit a release signal to the release mechanism to trigger the release mechanism to release the substance into the container.

### TECHNICAL FIELD

Example embodiments described herein generally related to security technology, and more particularly, relate to a security device for use in retail loss prevention.

### BACKGROUND

Product security devices are commonly used in a number of settings, including in retail theft prevention. In this regard, retail theft prevention systems, often referred to as electronic article surveillance (EAS) systems, use antennas located at the exits of a retail establishment to detect radio frequency (RF) signals emitted by a security device that is coupled to items for sale. A product security device may be affixed or locked to or around a product, and if the device is not removed at a point-of-sale during a sales transaction, the security device will be detected by the EAS system as the device, which is affixed to the product, leaves the store. An alarm may be triggered because the removal of the device from the retail establishment is likely to be associated with an attempted theft. However, if a thief should manage to remove a product from a retail establishment, despite the alarms, the thief may be able to use tools or more complex techniques to remove the security device from the product without damaging the product, thereby permitting the stolen product to be used or resold.

### SUMMARY OF SOME EXAMPLES

According to some example embodiments, a security device is provided. The example security device may comprise a container. The container is configured to receive an article within the container. The security device may further comprise a locking assembly affixed to the container. The locking assembly may be configured to lock the container to inhibit access to the article and unlock the container to permit access to the article. The security device may also include an electronic assembly affixed to the container. The electronic assembly may comprise a radio frequency receiver and processing circuitry. The processing circuitry may be coupled to the radio frequency receiver. Further, the security device may comprise a benefit denial assembly comprising a canister and a release mechanism. The canister may comprise a substance is disposed within the canister. The release mechanism may be configured to release the substance into the container. The release mechanism may be coupled to and triggerable by the processing circuitry. The processing circuitry may be configured to receive a gate detected signal from the radio frequency receiver in response to the radio frequency receiver receiving a wireless signal and, in response to receiving the gate detected signal from the radio frequency receiver, transmit a release signal to the release mechanism to trigger the release mechanism to release the substance.

According to some example embodiments, an example method is provided. The example method may comprise receiving, at processing circuitry of an electronic assembly, a gate detected signal from a radio frequency receiver of the electronic assembly in response to the radio frequency receiver receiving a wireless signal, and, in response to receiving the gate detected signal from the radio frequency receiver, transmitting a release signal to a release mechanism of a benefit denial assembly to trigger the release mechanism to release a substance disposed within the canister of the benefit denial assembly into a lockable container, wherein an article is disposed within the lockable container.

### BRIEF DESCRIPTION OF THE DRAWINGS

Having thus described the some example embodiments in general terms, reference will now be made to the accompanying drawings, which are not necessarily drawn to scale, and wherein:

FIG. 1 is a front plan view of a security device including a container in accordance with some example embodiments;

FIG. 2 is a top view of a security device in accordance with some example embodiments;

FIG. 3 is a rear plan view of a security device in accordance with some example embodiments;

FIG. 4 is a right side view of a security device in accordance with some example embodiments;

FIG. 5 is a partial front view of an upper end of a security device showing a hinge connection between a base and a lid of the container in accordance with some example embodiments;

FIG. 6 is an exploded front view of a lid of a security device in accordance with some example embodiments;

FIG. 7 is a bottom view of a lid of a security device in accordance with some example embodiments;

FIG. 8 is an exploded view of a lid of a security device in accordance with some example embodiments;

FIG. 9 is an exploded view of a battery holder assembly in accordance with some example embodiments;

FIG. 10 is top view of a battery holder assembly in accordance with some example embodiments;

FIG. 11 is a partial cut-away top view of a lid of a security device in accordance with some example embodiments;

FIG. 12 is a partial cross-sectional front view of a lid and a slider in an unlocked position as taken through line 12-12 of FIG. 11 in accordance with some example embodiments;

FIG. 13 is a partial cut-away top view of a lid in the unlocked position in accordance with some example embodiments;

FIG. 14 is a partial cross-sectional front view of a lid and a slider in a locked position as taken through line 14-14 of FIG. 13 in accordance with some example embodiments;

FIG. 15 is a partial cut-away top view of a lid in a locked position in accordance with some example embodiments;

FIG. 16 is a partial cross-sectional side view of a lid being engaged by a magnetic key to unlock the locking assembly in accordance with some example embodiments;

FIG. 17 is a block diagram of selected components of a security device in accordance with some example embodiments; and

FIG. 18 is a flow chart of an example method for a substance release benefit denial security device in accordance with some example embodiments.

### DETAILED DESCRIPTION OF SOME EXAMPLE EMBODIMENTS

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. As used herein, operable coupling should be understood to relate to direct or indirect connection that, in either case, enables functional interconnection of components that are operably coupled to each other.

According some example embodiments, an example security device for deterring retail theft by having functionality to release a substance to interface with the product as a benefit denial technique is provided. The example security device may comprise a lockable container within which, a retail product may be secured. The security device may also include an electronic assembly comprising a radio frequency (RF) receiver, such as, an electronic article surveillance (EAS) tag. The electronic assembly may also include processing circuitry. Further, the security device may include a benefit denial assembly comprising a canister filled with a substance, such as for example, an expanding foam. The benefit denial assembly may further include a release mechanism configured to release the substance into the container to interact with the product in response to a theft condition. According to some example embodiments, releasing the substance may include opening an orifice in the canister (e.g., by piercing the canister). The release mechanism may be coupled to and triggerable by the processing circuitry. In this regard, the processing circuitry may be configured to trigger the release mechanism in response to receiving an indication that the RF receiver received a wireless signal from, for example, an EAS gate installed at an exit of a retail establishment, which would indicate a possible theft. The triggered release mechanism may release the substance into the canister to fill the container with the substance in the canister. The substance may interact with the retail product in the container to either damage or adhere to the product to perform a benefit denial function.

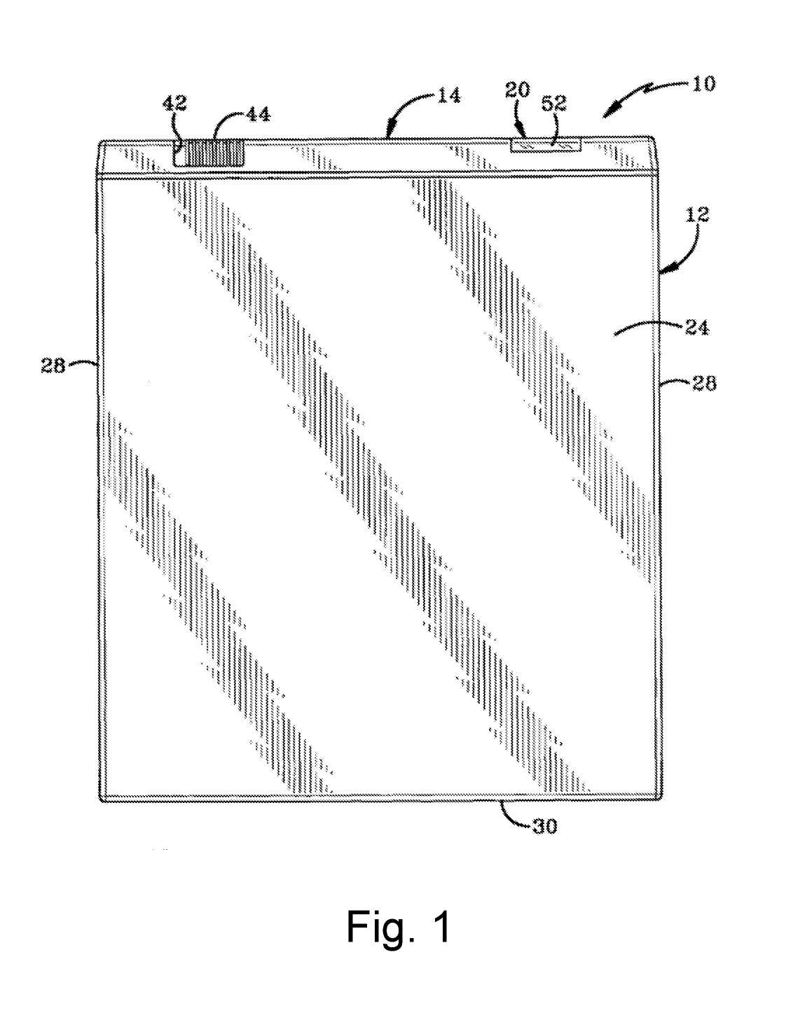

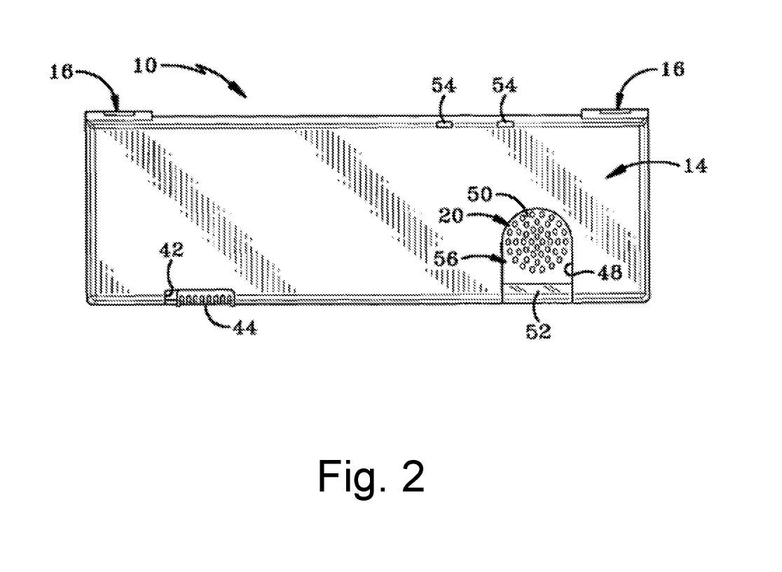

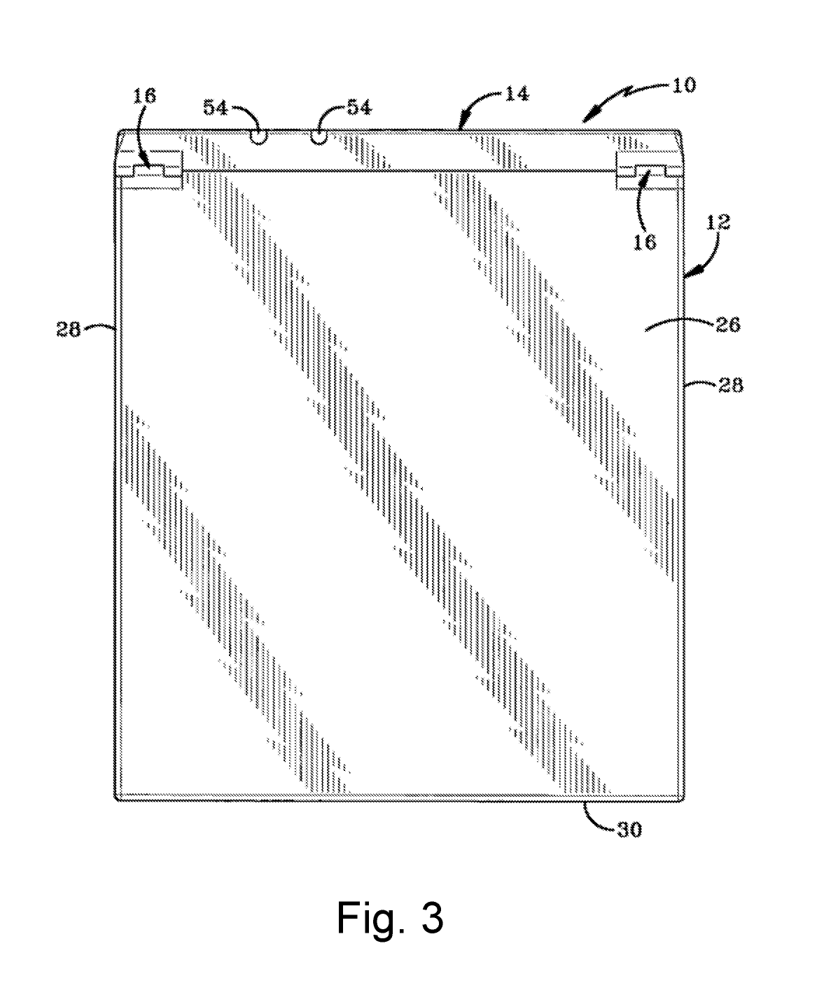

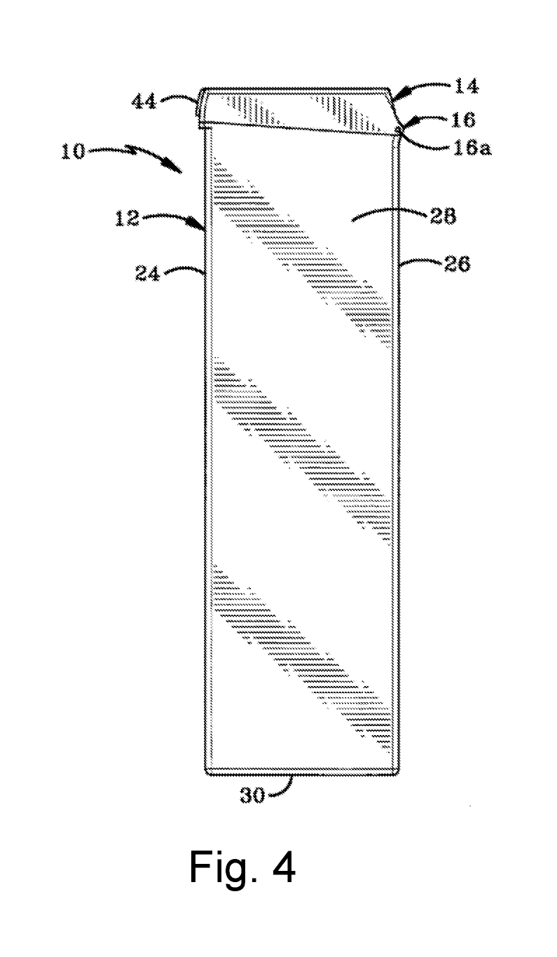

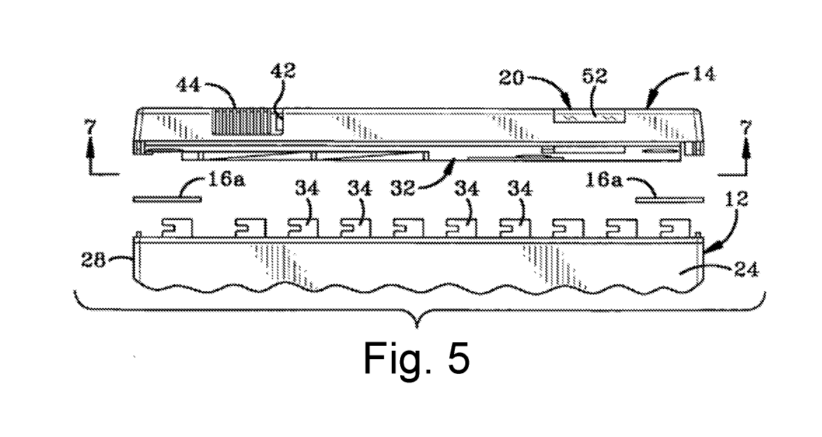

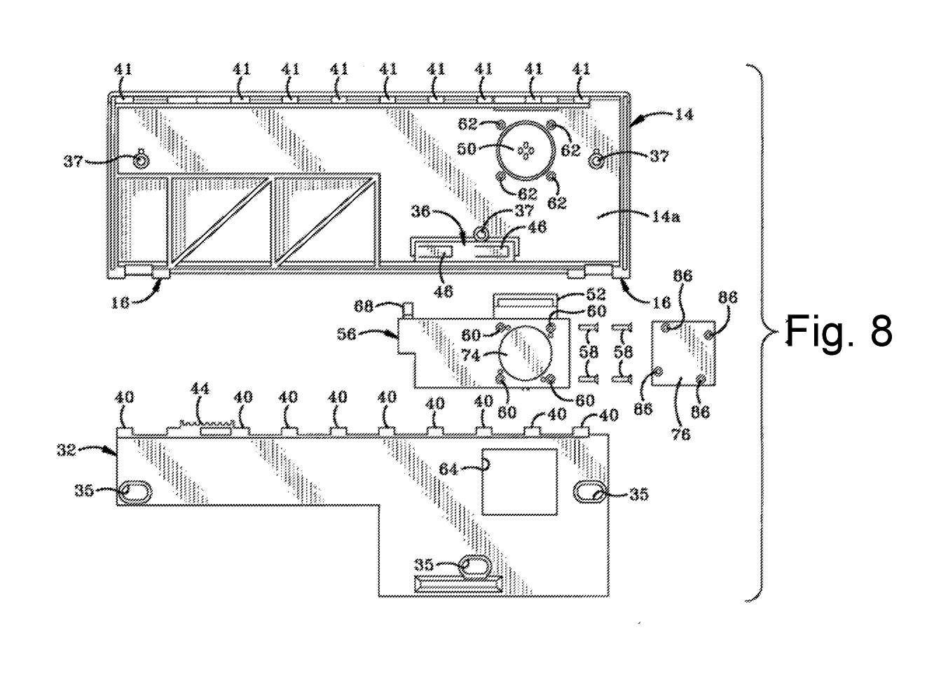

Referring to FIGS. 1-16, an example security device 10 may comprise a container formed by a base 12 and a lid 14. Together, the base 12 and the lid 14 may form a six-sided box. The lid 14 may be hingedly connected or affixed to base 12 and movable between open and closed positions. Base 12 may be sized to receive an article such as an item of merchandise (not shown). Lid 14 may cooperate with base 12 to surround and secure the article when lid 14 is in the closed position. Lid 14 preferably is pivotally mounted to base 12 by way of a hinge 16. Security device 10 may also include a locking assembly, generally indicated at 18 (FIG. 8), for securing lid 14 and base 12 together and preventing the unauthorized removal of the article from within base 12. Security device 10 may also include an electronic assembly, generally indicated at 20. Electronic assembly 20 may include a light, such as an LED 82, to indicate that security device 10 is armed, an EAS tag 84, and an audio device, such as a sound emitting speaker 80. One or more of the components of the electronic assembly 20 may be triggered when, for example, an attempt is made to pry lid 14 off base 12, when the electronic assembly 20 is brought into the proximity of a security gate of a store, or if security device 10 is removed from the store without first disarming the electronic assembly 20 with a key 22 (FIG. 16). Security device 10 with its integral electronic assembly 20 may be designed to be used as part of a security system for merchandise such as the system disclosed in pending U.S. application Ser. No. 11/312,266, filed Dec. 20, 2005, and entitled “Electronic Security Device and System for Articles of Merchandise”, (now abandoned) which application claimed priority from U.S. Provisional Application Ser. No. 60/639,770, filed Dec. 28, 2004; The entire specifications of these two applications are incorporated herein by reference.

Security device 10 may be adapted to receive an article, such as items of merchandise including CD or DVD packages, or the security device 10 may be configured to hold other items of merchandise such as computer software boxes, books, jewelry boxes, electronics boxes and the like. Base 12 is typically manufactured from a transparent material that allows the customer to view the article held within security device 10. Base 12 may include a front wall 24, back wall 26, and opposing left and right side walls 28 which extend upwardly and outwardly away from a bottom wall 30. Walls 24, 26, 28 and 30 may be disposed in the form of a five-sided frame or box having an open end disposed opposite bottom wall 30.

Lid 14 may be pivotally connected to base 12 by hinges 16 which may be rotatable about hinge-pins 16a. Lid 14 may close the open end of the box when lid 14 is in the closed position and may allow access to the interior cavity of the box when lid 14 is in the open position. Lid 14 may be manufactured from an opaque material so that, for example, an observer cannot determine if an EAS tag is present within lid 14 and also cannot view the various components of the locking assembly for securing security device 10 in a closed and locked position. Lid 14 may be locked to base 12 by any suitable locking assembly or mechanism including mechanically-actuated devices and magnetically actuated devices. However, an example of a suitable locking mechanism is the mechanism shown and described in pending U.S. patent application Ser. No. 10/371,570, filed Dec. 21, 2003, now U.S. Pat. No. 7,194,879. The entire specification of application Ser. No. 10/371,570 is incorporated herein by reference.

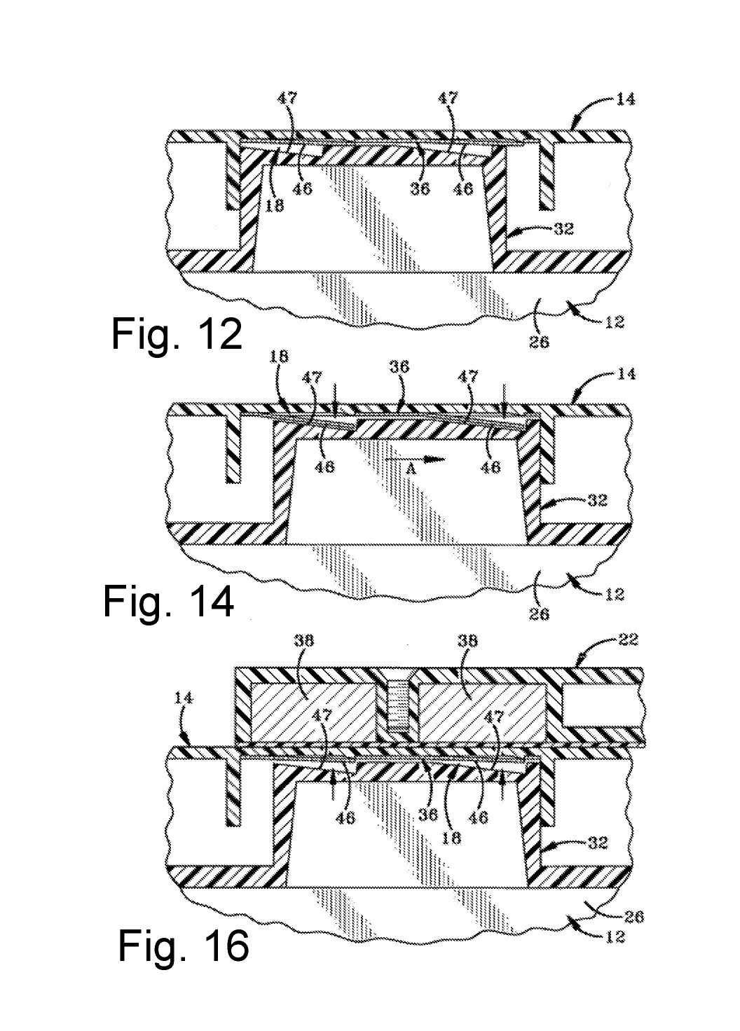

Lid 14 may be locked to base 12 by a slider 32, which may be slidably secured to an interior surface of lid 14, and by a locking assembly 18 (FIG. 8). Slider 32 may be slidably secured to lid 14 by a plurality of fasteners 33 which may be received through slots 35 in slider 32 and into bosses 37 formed in the interior surface 14a of lid 14. Slider 32 may be selectively slidable relative to the interior surface 14a of lid 14 and may be moveable between locked and unlocked positions. Locking assembly 18 may comprise a magnetically actuated locking arm 36 that has two spring-biased moveable fingers 46. Arm 16 and fingers 46 may be designed to engage a portion of slider 32 that includes angled pockets 47. Pockets 47 may be sized and shaped to receive fingers 46 therein and to prevent the withdrawal of the same therefrom unless the fingers 46 are acted upon by the magnetic key 22. Locking assembly 18 may hold slider 32 in the locked position when locking assembly 18 is in its locked position, i.e., when fingers 46 are retained within pockets 47. Locking fingers 46 may be moved from the locked position (FIG. 14) to an unlocked position (FIGS. 12 & 16) by using key 22. Key 22 may have magnets 38 disposed so as to align with the fingers 46 on locking arm 36 when key 22 is correctly positioned on lid 14. Magnets 38 attract fingers 46 toward the magnets 38 and, once fingers 46 are realigned with locking arm 36, the user can manipulate the finger tab 44 and slide slider 32 back into the open position. It will be understood that locking assembly 18 may be carried by either lid 14 or slider 32 and may engage pockets 47 formed on the other of lid 14 and slider 32 depending on the particular design of locking mechanism 36.

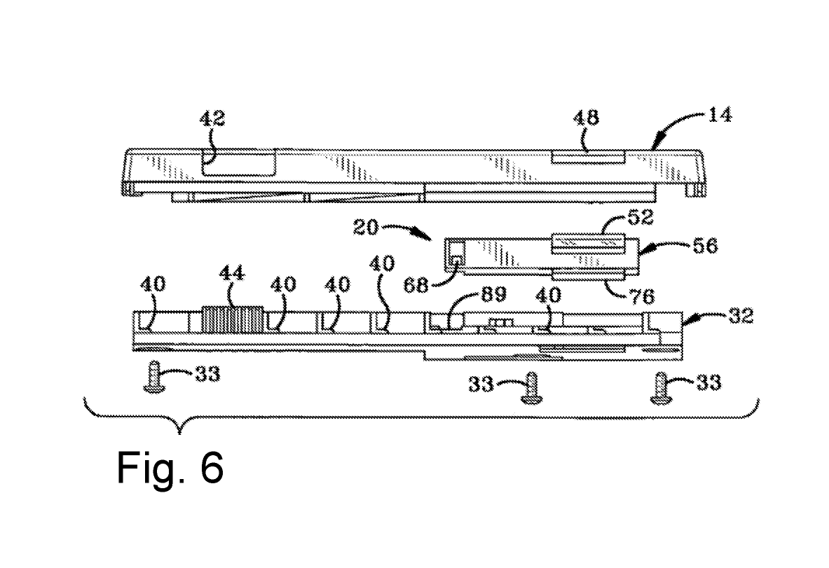

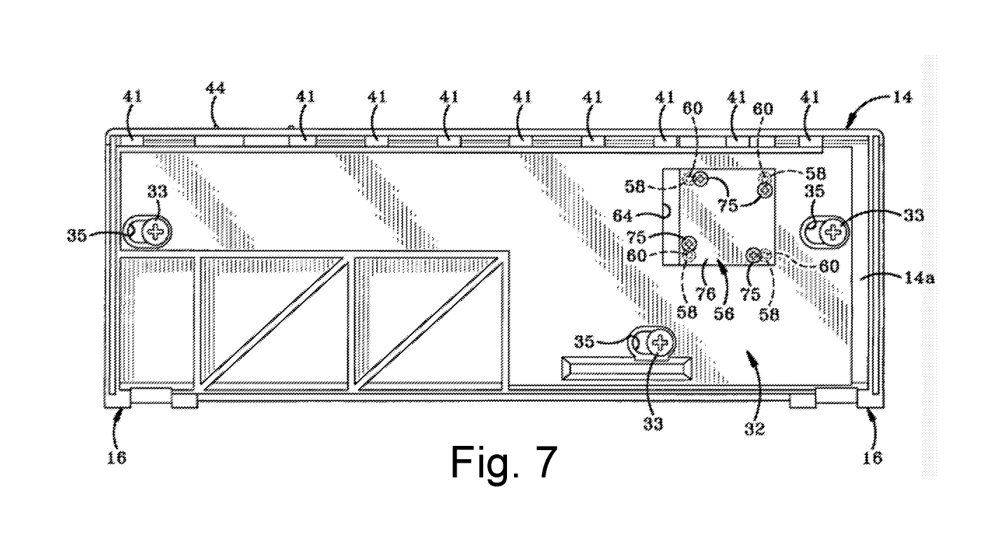

Slider 32 may include a plurality of spaced L-shaped lock tabs 40 which are shown in FIGS. 6 and 8. Lid 14 may include a plurality of spaced apart tabs 41 which may be seen in FIGS. 7 and 8. Furthermore, the front wall 24 of base 12 may include a plurality of spaced-apart hook tabs 34 which extend upwardly and outwardly therefrom. Each hook tab 34 may include a U-shaped slot that lies substantially parallel to the upper edge of the front wall 24. Tabs 34, 40 and 41 are typically integrally fabricated with base 12, slider 32 and lid 14, respectively. When slider 32 is secured to lid 14, the lower leg of each of the L-shaped lock tabs 40 may abut an outer surface of one of the tabs 41. Hook tabs 34 and lock tabs 40 may engage each other and disengage from each other when slider 32 is slidably moved between the locked and unlocked positions. When slider 32 is moved to lock lid 14 and base 12 together, the lower leg of each lock tab 40 may slide along the upper surface of the associated tab 41 and into the U-shaped slot of the adjacent hook tab 34. This interlocking of lock tabs 34 and 40 substantially prevents lid 14 from being pivoted from a closed position to an open position and security device 10 is therefore locked. When slider 32 is moved in the opposite direction, the lower legs of lock tabs 40 slide out of the U-shaped slot of the associated hook tab 34. Lid 14 may then be in an unlocked state where it may be pivoted between a closed and an open position to allow access to the interior cavity in base 12.

Lid 14 is also provided with an aperture 48 which receives a speaker grille 50 and light post 52 of electronic assembly 20; and is furthermore provided with a pair of alignment indicators 54 which are used to correctly position key 22. Speaker grille 50 and light post 52 may be integrally formed with a battery holder assembly 56 (FIG. 6) which is sandwiched between lid 14 and slider 32. Battery holder assembly 56 may be fixedly connected to lid 14 by a plurality of fasteners 58 (FIG. 7) which extend through mounting holes 60 in assembly 56 and into bosses 62 (FIG. 8) which are integrally formed on interior surface 14a of lid 14.

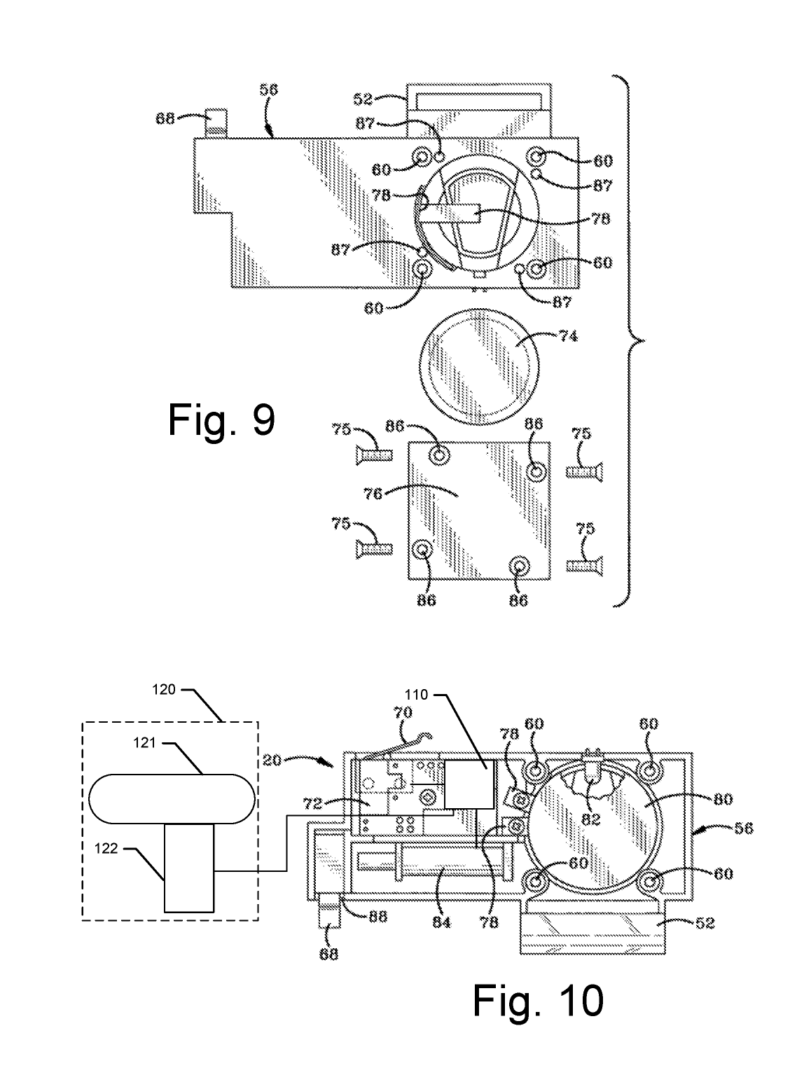

Battery holder assembly 56 is provided with the circuitry and other components of electronic assembly 20. In particular, battery holder assembly 56 may include at least a pair of switches 68, 70; a solid state circuit board 72 which substantially controls the electronic assembly; a battery 74 and associated battery cover 76, battery terminals 78; a speaker 80 (FIG. 10) a light-emitting diode (LED) 82 positioned to emit light toward light post 52; and the EAS tag 84. The LED 82 may be designed to flash when electronic assembly 20 is activated. The EAS tag 84 may be radio frequency (RF) sensitive or magnetically sensitive (AM) and is designed to actuate a security gate alarm when it is detected by the security gate. In this regard, the EAS tag 84 may be an example of an RF receiver 113 (FIG. 16). Switch 68 extends outwardly through an opening 88 in battery holder assembly 56 and through a slot 89 (FIG. 6) in slider 32. Switch 70 may extend outwardly from assembly 56 and into engagement with a projection 90 on slider 32. Battery cover 76 may be secured to battery holder assembly 56 by a plurality of fasteners 75 which are inserted through holes 86 in cover 76 and into holes 87 (FIG. 9) in assembly 56. Slider 32 also includes an aperture 64 through which battery cover 76 extends for a short distance. Fasteners 75 may be easily accessed through aperture 64. As may be seen in FIG. 8, aperture 64 may be smaller in length and width than battery holder assembly 56, but may be wider than battery cover 76. The additional width of aperture 64 may be provided so that as slider 32 moves back and forth, battery cover 76 is not engaged by slider 32.

Although not specifically shown in the attached figures, electronic assembly 20 also includes a plurality of sensors connected to circuit board 72. The sensors may monitor the state of the electric circuit in the system and indicate when the circuit is broken. In the event of an interruption in the circuit, a signal is sent by the circuit board 72 to sound the internal audible alarm in the system.

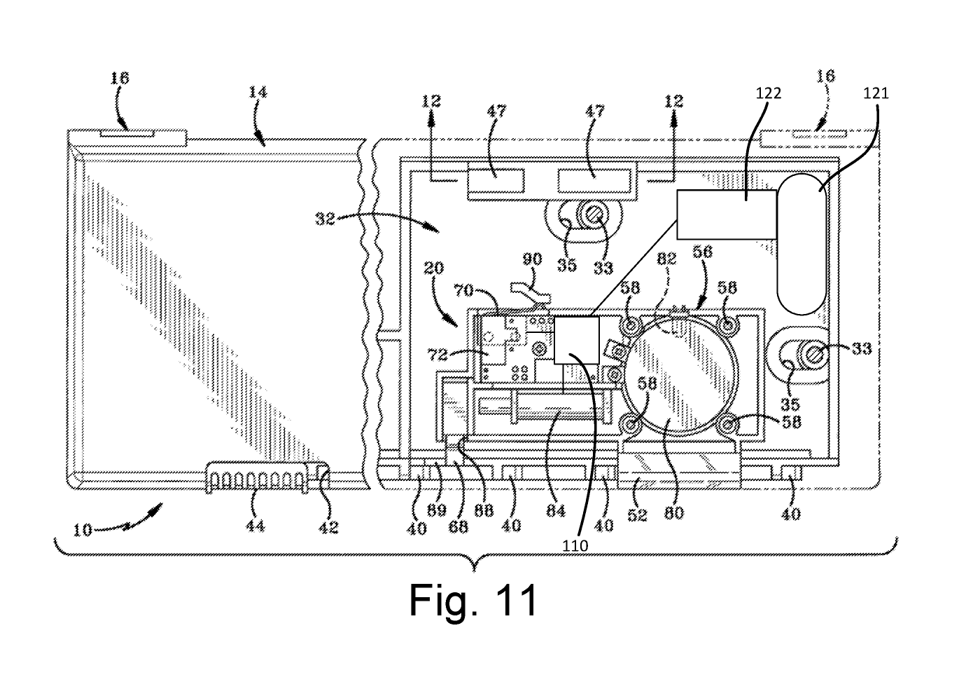

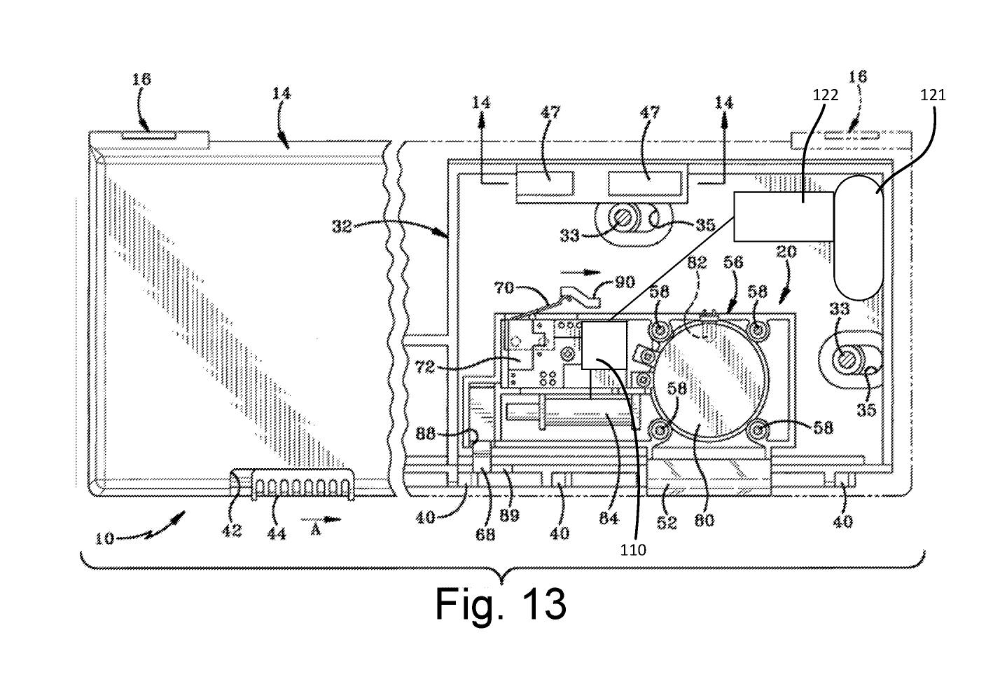

The security device 10 may be used in the following manner. When locking assembly 18 is in the unlocked position (FIGS. 11 & 12), lid 14 may be opened to allow for the insertion of an article into base 12. Lid 14 may then be rotated to close the open end of base 12. The user may then push finger tab 44 in the direction of the arrow “A” (FIG. 13), causing the slider 32 to move in the direction of the arrow “A”. As previously described, this movement causes lock tabs 40 and hook tabs 34 to engage each other. As shown in FIG. 14, movement of slider 32 may also cause fingers 46 of lock arm 36 to slide into a position over pockets 47. Fingers 46 may be spring-biased into alignment with the planar lock arm 36. Consequently, when fingers 46 are disposed over pockets 47, they spring out of alignment with arm 36 and become engaged in pockets 47 thereby further locking lid 14 and base 12 together. Furthermore, as shown in FIG. 13, movement of slider 32 causes switch 70 to ride along projection 90 thereby causing switch 70 to move into a position where the electric circuit in security device 10 is closed. The movement of slider 32 also causes switch 68 to slide in opening 88 and slot 89 into a position where the electric circuit is closed. The closing of the electric circuit may cause LED 82 to begin to emit light, that light being magnified and seen through light post 52 on lid 14. LED 82 may indicate to the consumer that the security device 10 is now alarmed. Preferably LED 82 is configured to blink so as to direct the consumer's attention to the fact that security device 10 is alarmed. Furthermore, the closure of the circuit results in power being supplied to the EAS tag 84 and to the speaker 80. Consequently, if any attempt is made to pry lid 14 from base 12, the sensors in alarm system 20 will be triggered and the speaker 80 will emit a loud, attention-getting sound. The security device 10 can be preprogrammed to emit a sound for a predetermined length of time, such as 10 minutes for example. Furthermore, even if no attempt is made to pry lid 14 from base 12, if security device 10 is brought within a certain preprogrammed range of a security gate at an entrance or exit of the protected environment, the EAS tag 84 will be triggered and thereby cause the security gates to sound a remote alarm. Simultaneously, the speaker 80 in security device 10 will also begin to emit a loud, attention-getting sound. The alarm may only be switched off by engaging security device 10 with specially designed key 22.

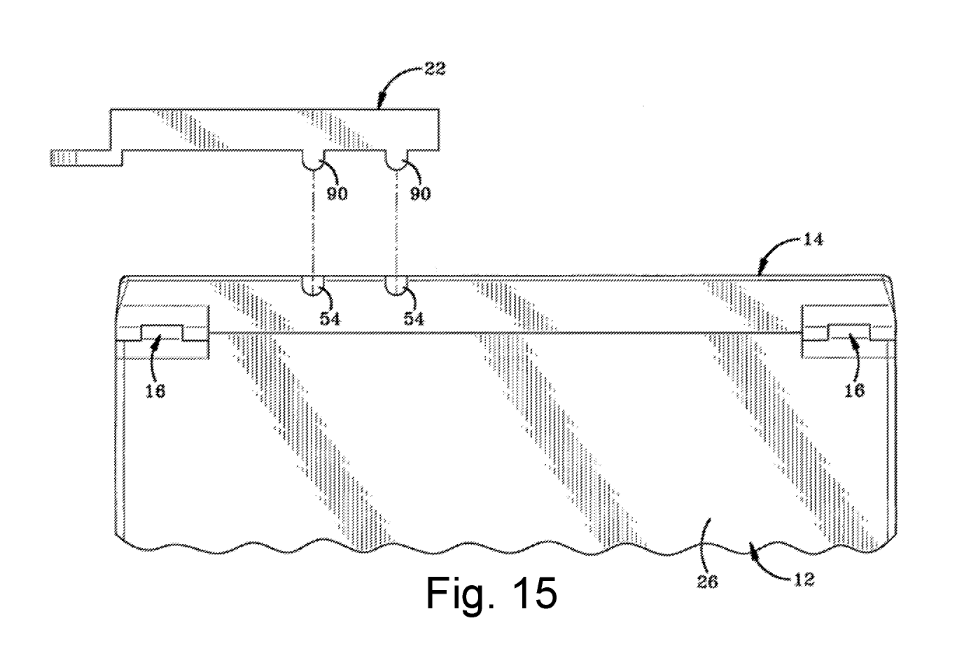

In order to prevent the electronic assembly from being triggered to sound an alarm after the merchandise has been legally purchased by the customer, security device 10 can be disarmed by aligning key 22 with locking assembly 18. Key 22 may be correctly aligned on security device 10 by protrusions 90 (FIG. 15) on key 22 into apertures 54 on lid 14. This brings magnets 38 (FIG. 16) into the proximity of fingers 46 on locking assembly 18. Fingers 46 are attracted toward magnets 38 and are thereby withdrawn from pockets 47 in base 32. The finger tab 44 may then be moved in the opposite direction to the arrow “A”, thereby moving slider 32 in the opposite direction to the arrow “A” relative to lid 14. As slider 32 moves in this second direction, switch 70 slides along projection 90 from the position shown in FIG. 13 to the position shown in FIG. 11. Furthermore, switch 68 slides in the opposite direction through opening 88 and slot 89. The movement of switches 68 and 70 may break the electric circuit in security device 10, thereby disarming the electronic assembly 20. The movement of slider 32 in the opposite direction to the arrow “A” may also cause lid 14 to be unlocked. Lid 14 can then be rotated into the open position and the article may be removed from within base 12.

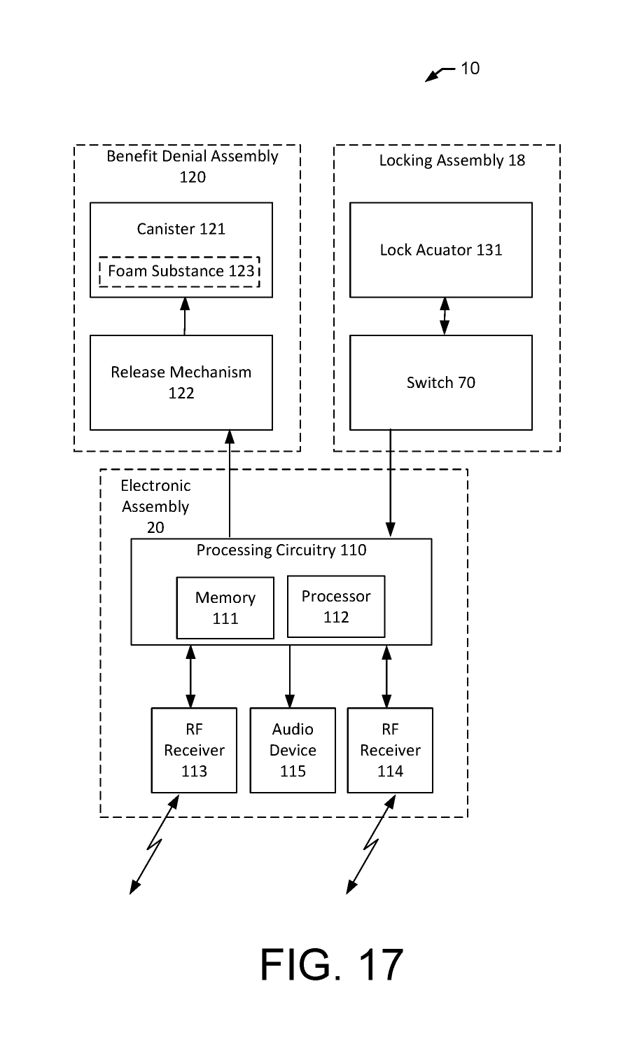

With reference now to FIG. 17, a block diagram of selected components of the security device 10 are shown. In this regard, the electronic assembly 20 is shown with processing circuitry 110. Processing circuitry 110 may include a processor 112 and a memory 111. The processor 112 may be any type of microprocessor, field programmable gate array (FPGA), or application specific integrated circuit (ASIC). The processor 112 may be configured either in hardware or through the execution of software instructions (e.g., stored in the memory 111) to embody and implement functionalities to support the operation of the security device 10. The processor 112 may include input/output pins or connections that permit the processor 110 and the processing circuitry 110 to interface with, receive information from, and control the operation of, peripheral components. The memory 111 may be separate from or integrated with the processor 112.

In this regard, the processing circuitry 110 may be directly or indirectly connected to an RF receiver 113. The RF receiver 113 may be an EAS tag, such as EAS tag 84. In this regard, the RF receiver 113 may be configured to receive a wireless signal emitted by a EAS security gate at an ingress or egress to a retail establishment. The RF receiver 113 may receive the signal from the EAS security gate when the security device 10 is in relatively close proximity to the EAS security gate, and therefore an ingress or egress to the retail establishment. The RF receiver 113 may be configured to operate at frequencies that are common for EAS security gates, such as, for example, about 8.2 MHz or about 58 kHz. The RF receiver 113 may comprise and inductor and a capacitor that form an LC tank circuit that resonates to transmit a return signal to the EAS security gate to trigger an alarm at the EAS security gate.

The RF receiver 113 may also be directly or indirectly connected to the processing circuitry 110. In this regard, the processing circuitry 110 may be configured to monitor the RF receiver 113 to determine whether the RF receiver 113 has received a wireless signal from an EAS security gate. In response to receiving a wireless signal from an EAS security gate, the RF receiver 113 may be configured to provide a gate detected signal to the processing circuitry 110 for receipt by the processing circuitry 110. Receipt of the gate detected signal at the processing circuitry 110 may operate to initiate a number of functionalities of the security device 10 as further described herein.

For example, the receipt of the gate detected signal may cause the processing circuitry 110 to trigger functionalities associated with the benefit denial assembly 120. The benefit denial assembly 120 may be disposed within the security device 10, and more specifically, within the lid 14. The benefit denial assembly 120 may comprise a release mechanism 122 and a canister 121. The canister 121 may be a tube or containment device (e.g., formed of aluminum) for encasing a substance, such as, for example, an expanding foam substance 123 (e.g., polyurethane foam). According to some example embodiments, the substance may be a liquid or a gel that may mark, damage, deface, or adhere to the article within the container (e.g., bleach, dye, or the like). According to some example embodiments, the substance may be one that changes state from a liquid or gel to a solid when released into the container and exposed to air, the environment, or a change in pressure or temperature. In this regard, the canister 121 may be pressurized. The release mechanism 122 may be an apparatus that is controlled by the processing circuitry 110 to release a substance into the container of the security device. In this regard, for example, the release mechanism 122 may be configured to release the substance by opening an orifice in the canister 121 to release, in this example, the expanding foam substance 123, into the container and more specifically the base 12 of the security device 10 to engage, damage, or prevent removal of the article in the security device 10, thereby performing a benefit denial function in the event that the article, with the security device 10, are attempted to be stolen.

According to various example embodiments, the release mechanism 122 may be configured to operate in a number of different ways to release the substance into the container of the security device 10 in response to receiving a release signal from the processing circuitry 110. According to some example embodiments, the substance may, for example, be pumped, using a pump device that is part of the release mechanism 122 and controlled by the processing circuitry 110 using the release signal, into the container of the security device 10. In this regard, the processing circuitry 110 may control a component, such as a piezo, to cause a vibration that creates a pump action to agitate and release the substance from the canister 121. According some example embodiments, the substance may be released by opening an orifice in the canister 121. In this regard, the release mechanism 122 may be configured to receive a release signal from the processing circuitry 110 and, in response, perform a mechanical actuation to open an orifice in the canister 121. The mechanical actuation may be, for example, to control a solenoid to release a biased pin towards the canister 121 to pierce the canister 121 and thereby open the orifice in canister 121. Alternatively, the canister 121 may be outfitted with a nozzle, and the processing circuitry 110 may be configured to transmit the release signal to an actuator, such as a motor that turns to engage the nozzle or otherwise moves the nozzle to open the orifice in the canister 121 to release the expanding foam substance 123. Further, according to some example embodiments, the canister 121 may include a plug and the release mechanism 122 may be configured to actuate a motor, solenoid, or the like to remove the plug from the canister 121 to open the orifice in the canister 121.

According to some example embodiments, a timer delay may be employed by the processing circuitry 110 prior to transmitting the release signal to the release mechanism 122. In this regard, the processing circuitry 110 may be further configured to, in response to receiving the gate detected signal from the radio frequency receiver, commence a timer. Accordingly, the processing circuitry 110 may be further configured to transmit the release signal to the release mechanism 122 in response to receiving the gate detected signal from the RF receiver 113 and the timer reaching a threshold value. In this regard, the timer may not be commenced until the processing circuitry 110 receives the gate detected signal and the timer may then count down or up to a threshold value (e.g., zero if counting down). Upon reaching the threshold value, the processing circuitry 110 may proceed to transmit the release signal to the release mechanism 122. According to some example embodiments, the time may reach the threshold value in, for example, one minute, five minutes, or the like. Additionally, according to some example embodiments, the processing circuitry 110 may be configured to direct the audio device to emit a sound (e.g., a repeated short tone) while the timer is running.

By employing a timer as described above, the security device 10 may offer the opportunity to interrupt the benefit denial process, if, for example, store personnel accidentally did not remove the article from the security device 10 after the item had been properly purchased. In this regard, the processing circuitry 110 may be configured to detect an action taken by store personnel in response to such a situation and stop or cancel the timer to avoid release of the expanding foam substance 123. The processing circuitry 110 may therefore be configured to receive a disarm signal and, in response to receiving the disarm signal, stop the timer (i.e., prevent the timer from reaching the threshold value).

The disarm signal may be initiated in a number of ways, according to various example embodiments. For example, the disarm signal may be provided via the switch 70 of the locking assembly 18. In this regard, when the locking assembly 18 is transitioned to the unlocked state (e.g., as described above), a lock actuator 131 (e.g., the slider 32 or the like) may cause the state of the switch 70 to change, thereby providing the disarm signal to the processing circuitry 110. Since, according to some example embodiments, the key 22 is required to transition the locking assembly 18 to the unlocked position, and the key 22 should only be in the possession of the store personnel, the disarm signal, in this regard, may be provided only when store personnel have taken action to disarm the security device 10 to prevent the release of the expanding foam substance 123 into the container.

Alternatively, the disarm signal may be provided to the processing circuitry 110 by the RF receiver 113 or another RF receiver 114. In this regard, for example, the RF receiver 113 may receive a wireless disarm signal (i.e., different from the standard wireless gate signal emitted by an EAS gate, such as, for example, a higher power signal), and provide a disarm signal to the processing circuitry 110. Similarly, the electronic assembly 20 may include a second RF receiver 114, which may include an RF antenna that operates at frequency different than an EAS gate. According to some example embodiments, the RF receiver 114 may be a coil associated with a transformer used to excite the audio device 115 that is monitored by the processing circuitry 110. In this regard, according to some example embodiments, the key 22 may include an RF transmitter configured to transmit a wireless disarm signal to the security device 10. The wireless disarm signal transmitted by the key 22 may be received by the RF receiver 114, and the RF receiver 114 may responsively provide the disarm signal to the processing circuitry 110 to stop the timer.

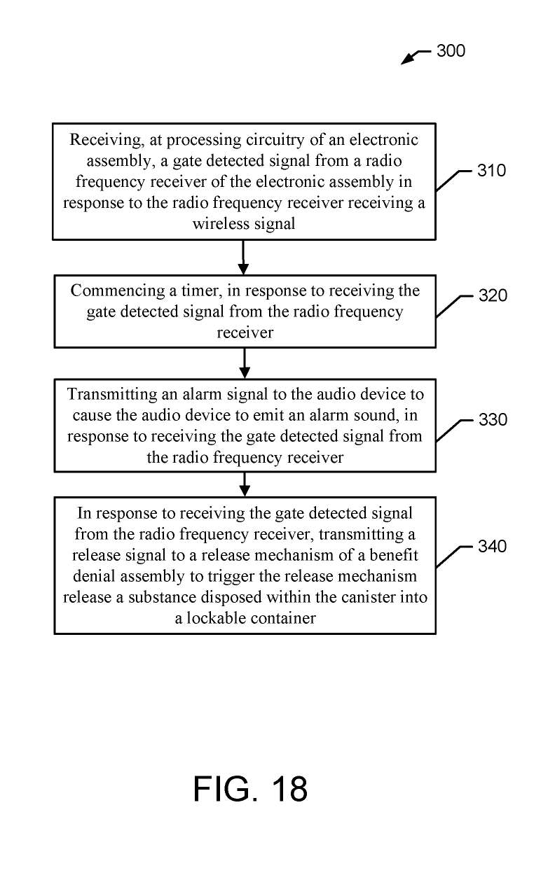

FIG. 18 shows a flow chart of an example method 300 for a substance release benefit denial security device, such as, security device 10 described above. The example method 300 may include at 310, receiving, at processing circuitry of an electronic assembly, a gate detected signal from a radio frequency receiver of an electronic assembly. The gate detected signal may be provided to the processing circuitry in response to the radio frequency receiver receiving a wireless signal. Further, at 320, the example method 300 may include commencing a timer. The timer may be commenced in response to receiving the gate detected signal from the radio frequency receiver. At 330, the example method 300 may include transmitting an alarm signal to the audio device to cause the audio device to emit an alarm sound, in response to receiving the gate detected signal from the radio frequency receiver. Additionally, the example method 300 may include, at 340, in response to receiving the gate detected signal from the radio frequency receiver and, according to some example embodiments, in response to the timer reaching a threshold value, transmitting a release signal to a release mechanism of a benefit denial assembly. By transmitting the release signal, the release mechanism may be triggered to release a substance disposed within the canister into a lockable container.

Many modifications and other embodiments set forth herein will come to mind to one skilled in the art to which these inventions pertain having the benefit of the teachings presented in the foregoing descriptions and the associated drawings. Therefore, it is to be understood that embodiments are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A security device comprising:
a container, wherein the container is configured to receive an article within the container;
a locking assembly affixed to the container, the locking assembly being configured to lock the container to inhibit access to the article and unlock the container to permit access to the article;
an electronic assembly affixed to the container, the electronic assembly comprising:
a radio frequency receiver; and
processing circuitry, the processing circuitry being coupled to the radio frequency receiver;
a benefit denial assembly comprising:
a canister, wherein a substance is disposed within the canister;
a release mechanism configured to release the substance into the container, the release mechanism being coupled to and triggerable by the processing circuitry;
wherein the processing circuitry is configured to:
receive a gate detected signal from the radio frequency receiver in response to the radio frequency receiver receiving a wireless signal; and
in response to receiving the gate detected signal from the radio frequency receiver, transmit a release signal to the release mechanism to trigger the release mechanism to release the substance.

2. The security device of claim 1, wherein the electronic assembly further comprises an audio device, and wherein the processing circuitry is configured to, in response to receiving the gate detected signal from the radio frequency receiver, transmit an alarm signal to the audio device to cause the audio device to emit an alarm sound.

3. The security device of claim 1, wherein the substance is an expanding foam.

4. The security device of claim 1, wherein the processing circuitry is further configured to, in response to receiving the gate detected signal from the radio frequency receiver, commence a timer; and
wherein the processing circuitry is configured to transmit the release signal to the release mechanism in response to receiving the gate detected signal from the radio frequency receiver and the timer reaching a threshold value.

5. The security device of claim 4, wherein the processing circuitry is further configured to receive a disarm signal, and in response to receiving the disarm signal, stop the timer.

6. The security device of claim 5, wherein the locking assembly includes a switch configured to actuate into an unlocked position and provide the disarm signal in response to the locking assembly transitioning into an unlocked state.

7. The security device of claim 5, wherein the electronic assembly comprises a second radio frequency receiver, and wherein the disarm signal is provided by the second radio frequency receiver in response to receiving a wireless disarm signal.

8. The security device of claim 5, wherein the electronic assembly further comprises an audio device; and
wherein the processing circuitry is configured to:
in response to receiving the gate detected signal from the radio frequency receiver, transmit an alarm signal to the audio device to cause the audio device to emit an alarm sound; and
in response to receiving the disarm signal, transmit a stop alarm signal to the audio device to cause the audio device to discontinue emitting the alarm sound.

9. The security device of claim 1, wherein the radio frequency receiver comprises an inductor and a capacitor coupled to form a resonant circuit.

10. The security device of claim 9, wherein the resonant circuit is configured to resonate at about 58 kHz or about 8.2 MHz.

11. The security device of claim 1, wherein the container comprises a five-sided base hingedly affixed to a lid.

12. The security device of claim 11, wherein the electronic assembly and the benefit denial assembly are affixed to the hinged lid.

13. The security device of claim 11, wherein the five-sided shell is transparent.

14. The security device of claim 1, wherein the locking assembly is configured to be transitioned to an unlocked state through interaction with a magnetic key.

15. A method comprising:
receiving, at processing circuitry of an electronic assembly, a gate detected signal from a radio frequency receiver of the electronic assembly in response to the radio frequency receiver receiving a wireless signal; and
in response to receiving the gate detected signal from the radio frequency receiver, transmitting a release signal to a release mechanism of a benefit denial assembly to trigger the release mechanism to release a substance disposed within the canister of the benefit denial assembly into a lockable container, wherein an article is disposed within the lockable container.

16. The method of claim 15 further comprising transmitting an alarm signal to the audio device to cause the audio device to emit an alarm sound, in response to receiving the gate detected signal from the radio frequency receiver.

17. The method of claim 15 further comprising:
commencing a timer, in response to receiving the gate detected signal from the radio frequency receiver; and
wherein transmitting the release signal comprises transmitting the release signal to the release mechanism in response to receiving the gate detected signal from the radio frequency receiver and the timer reaching a threshold value.

18. The method of claim 15 wherein the container comprises a five-sided shell affixed to a hinged lid.

19. The method of claim 15 wherein the electronic assembly and the benefit denial assembly are affixed to a hinged lid of the container.

20. The method of claim 15 wherein the substance is an expanding foam.
